(19) United States
(12) Patent Application Publication
(10) Pub. No.: US 2011/0244966 A1
(43) Pub. Date: Oct. 6, 2011

(54) POKER CALCULATOR

(75) Inventor: Cameron Brown, Oakville (CA)

(73) Assignee: Delphin Trading Corp.

(21) Appl. No.: 12/738,036

(22) PCT Filed: Oct. 9, 2008
(86) PCT No.: PCT/CA2008/001788

§ 371 Date: Jun. 20, 2011

Related U.S. Application Data
(60) Provisional application No. 60/979,909, filed on Oct. 15, 2007.

(51) Int. Cl. A63F 13/00

(52) U.S. Cl. 463/47

(57) ABSTRACT

Apparatus for use by a player in a game of Texas Hold'em poker is disclosed and comprises and keyboard and a screen. The keyboard includes: a card identification key arrangement including one key for each of the cards of a standard 52-card deck suit; and a suitedness indicator key arrangement. Using the identification key arrangement, the user can: indicate, in two keystrokes, the cards constituting a hand; and indicate the number of players participating. Using the indicator key arrangement, the user can indicate, in a single keystroke, whether the cards in the hand are of the same suit. After the user has: indicated the cards constituting said hand; indicated the number of players participating; and indicated whether the cards in the are of the same suit, the screen displays information about the hand selected from: the pre-flop percentage odds of said hand winning the game; and the hand ranking.

### FIELD OF THE INVENTION

The present invention relates to the field of gaming.

### BACKGROUND OF THE INVENTION

Texas Hold'em is a popular poker variant played with a standard 52 card deck.

### Rules

Play begins with each player being dealt two cards face down. These are the only cards each player will receive individually. The hand begins with a “pre-flop” betting round. After the pre-flop betting round, assuming there remain at least two players taking part in the hand, the dealer deals a flop, to with, three face-up community cards. The flop is followed by a second betting round. After the flop betting round ends, a single community card (called the turn or fourth street) is dealt, followed by a third betting round. A final single community card (called the river or fifth street) is then dealt, followed by a final betting round. If a player bets and all other players fold, then the remaining player is awarded the pot and is not required to show his hole cards. If two or more players remain after the final betting round, a showdown occurs.

In the showdown, each player plays the best five-card poker hand he or she can make from the seven cards comprising his/her two hole cards and the five community cards. A player may use both of his/her own two hole cards, only one, or none at all, to form his/her final five-card hand. If the five community cards form the player's best hand, then the player is said to be playing the board and can only hope to split the pot, since each other player can also use the same five cards to construct the same hand. If the best hand is shared by more than one player, then the pot is split equally among them.

### SUMMARY OF THE INVENTION

An electronic calculator apparatus for use by a player holding a two-card hand in a game of Texas Hold'em poker forms one aspect of the invention. This apparatus comprises a keyboard and a screen. The keyboard includes: a card identification key arrangement including one key for each of the cards of a standard 52-card deck suit; and a suitedness indicator key arrangement. The user, using the card identification key arrangement, can: (i) indicate, in two keystrokes, the cards constituting said hand; and (ii) indicate the number of players, from 2-10, participating in said game. Further, the user, using the suitedness indicator key arrangement, can indicate, in a single keystroke, whether or not the cards in said hand are of the same suit.

The screen is adapted, after said user has: indicated the cards constituting said hand; indicated the number of players participating in said game; and indicated whether or not the cards in said hand are of the same suit, to display information about said hand selected from: the pre-flop percentage odds of said hand winning the game; and the ranking of the hand.

According to another aspect of the invention, the screen, in use, can display the pre-flop percentage odds of said hand winning the game and the ranking of the hand.

According to another aspect of the invention, the suitedness indicator key arrangement can comprise a suited key and a non-suited key such that the user can indicate: that the cards in said hand are of the same suit by a stroke of the suited key; and that the cards in said hand are not of the same suit by a stroke of the non-suited key.

According to another aspect of the invention, the keyboard can further comprise a player number key and a stroke of the player number key can trigger the apparatus to interpret further activation of a numeric key of the card identification key arrangement as an indication of the number of players participating in said game.

According to another aspect of the invention, the keyboard can further comprise a calculate key and a stroke of the calculate key can trigger the display of said information about said hand.

According to another aspect of the invention, after a user has: (i) indicated the cards in said hand using the card identification key arrangement; (ii) using the suitedness indicator key arrangement, indicated, via a single keystroke, whether or not the cards of said hand are of the same suit or not; and (iii) indicated the number of players in the game using the card identification key arrangement, the screen can display the pre-flop percentage odds of said hand winning the game and the ranking of the hand.

According to another aspect of the invention, the keyboard can further comprise a calculate key and a stroke of the calculate key can trigger the screen to display said information about said hand.

According to another aspect of the invention, the keyboard can further comprise a player number key and a stroke of the player number key can trigger further activation of a numeric key of the card identification key arrangement to be interpreted as an indication of the number of players participating in said game.

According to another aspect of the invention, the apparatus can have outer dimensions equivalent to a stack of standard playing cards.

According to yet another aspect of the invention, the apparatus can be adapted to receive sufficient data to display said information about said hand in 6 or fewer keystrokes.

Other advantages, features and characteristics of the present invention will become more apparent upon consideration of the following detailed description and the appended claims with reference to the accompanying drawings, the latter being briefly described hereinbelow.

### BRIEF DESCRIPTION OF THE FIGURES

FIG. 1 is a front view of a calculator apparatus according to an exemplary embodiment of the invention;

FIG. 2 is a back view of the apparatus of FIG. 1;

FIG. 3 is an enlarged view of FIG. 1;

FIG. 4 is a perspective view of the apparatus of FIG. 1 overlaid upon a deck of playing cards; and

FIG. 5 is a perspective view of the apparatus of FIG. 1, stored.

### DETAILED DESCRIPTION

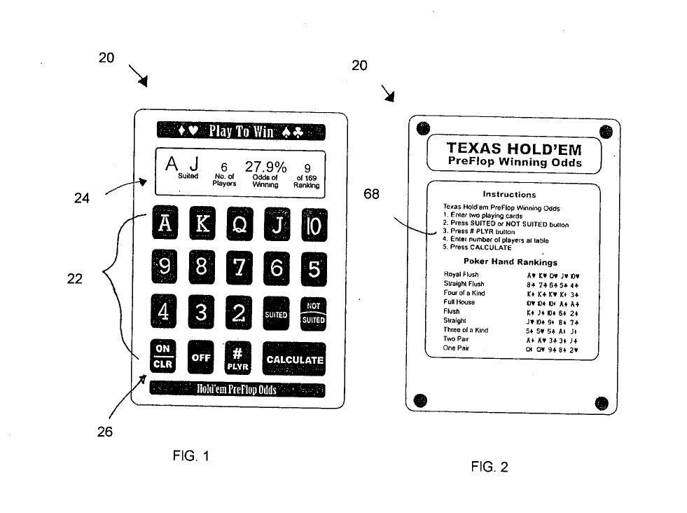

An electronic calculator apparatus according to an exemplary embodiment of the invention is illustrated in FIGS. 1-3 and designated with general reference numeral 20.

The calculator apparatus takes the general form of a conventional electronic calculator having a keyboard 22, a liquid crystal screen 24, an on/clear key 26, a power off key 27 and an interior microprocessor and power source, i.e. a battery (neither shown) operatively connected to the keyboard 22, screen 24 and on/off keys 26,27. As the manner in which electronic calculators can be constructed is a matter of routine to persons of ordinary skill in the art, only the manner in which the calculator of the exemplary embodiment differs, is hereinafter described.

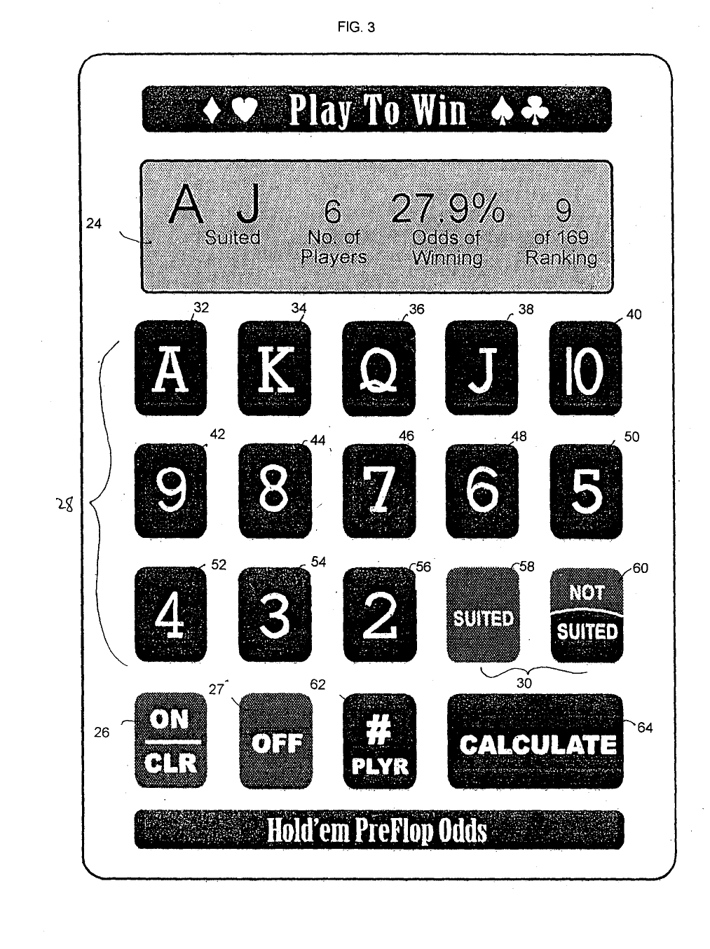

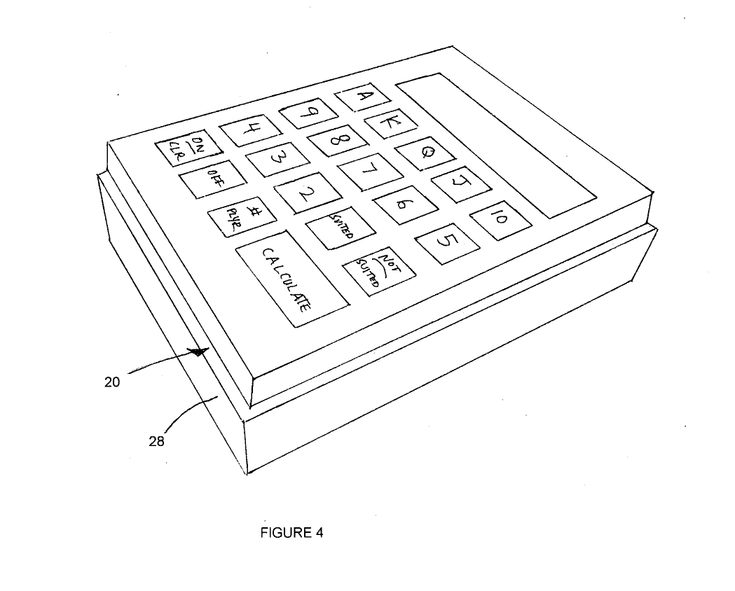

In this regard, the calculator should initially be understood as having outer dimensions substantially equivalent to a stack of standard playing cards, as shown in FIG. 3. An instruction sheet 68 bearing instructions and poker hand rankings is provided on the back side of the housing, as shown in FIG. 2.

With regard to the keyboard of the exemplary embodiment, same includes a card identification key arrangement 28 and a suitedness key arrangement 30.

The card identification key arrangement 28 includes one key for each of the cards of a standard 52-card deck suit, namely, Ace 32, King 34, Queen 36, Jack 38, Ten 40, Nine 42, Eight 44, Seven 46, Six 48, Five 50, Four 52, Three 54 and Two 56.

The suitedness indicator key arrangement 30 comprises a suited key 58 and a non-suited key 60.

The keyboard 22 further comprises a player number key 62 and a calculate key 64.

The apparatus 20 is for use by a player in the pre-flop betting round in a game of Texas Hold'em poker.

In use, the player turns on the calculator apparatus 20, if it is not already active, by pressing the on/clear key 26.

Once activated, the player, using the card identification key arrangement 28, enters, in two keystrokes, the cards constituting his or her hand before the flop. For example, if the player holds an Ace and a Jack in the hole, the player strokes the Ace 32 and Jack 38 keys, triggering on the screen 24 the appearance of indicia corresponding thereto, such as the A (for Ace) and J (for Jack) shown in FIGS. 1,3.

If the player enters a pair, the screen 24 displays the word pair (not shown).

If the player does not enter a pair, and the cards in said hand are of the same suit, the user strokes the suited key 58, in which the display reads “Suited”, as shown in FIGS. 1,3. Alternatively, if the cards in said hand are not of the same suit, the user strokes the non-suited key 60, which triggers a “Non-suited” read-out (not shown). If the player enters a pair, the cards cannot be suited, and the apparatus defaults to the non-suited condition.

The next step for the player is to stroke the player number key 62, and to thereafter, indicate the number of players in the game, by striking the appropriate one of the keys on the card identification key arrangement 28. For example, if there are six players in the game, the players strikes the Six key 48, which triggers the appearance of a numeral on the screen 24 commensurate with the keystroke, i.e., the numeral 6 on the screen, as shown in FIGS. 1 and 3. The exemplary apparatus has a default setting of two players. Thus, if only two players are participating in the game, this step can be skipped.

As a final step, a stroke of the calculate key 64 causes the screen 24 to display the pre-flop percentage odds of said hand winning the game and the ranking of the hand amongst all possible hands, i.e. 27.9% and 9, respectively, for a player in a 6 person game holding an Ace and a Jack of the same suit in the hole, as indicated in FIGS. 1 and 3. In this regard, the microprocessor of the exemplary embodiment has recourse to an electronically encoded look-up table incorporating odds and ranking information for the various possible permutations, as appended hereto.

The apparatus 20 of the exemplary embodiment triggers the odds/ranking display in 5 keystrokes, in the case of a pair, or 6 keystrokes otherwise.

This device accordingly is a convenient recourse to players, who can quickly enter the hole cards dealt and determine whether or not to participate in the betting rounds, without inconveniencing other players or substantially slowing down play.

At the same time, the use of a look-up table permits the use of a low cost microprocessor, thereby rendering the calculator relatively inexpensive and indeed, largely disposable.

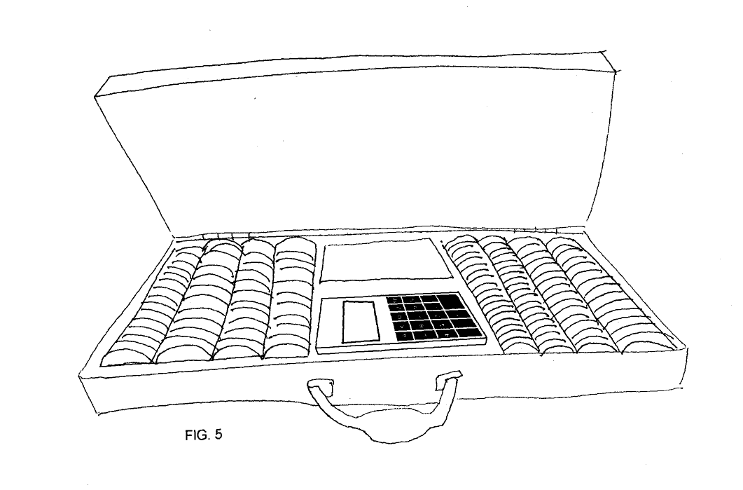

Finally, the outer dimensions permit the calculator to be neatly stored, for example, in the socket, provided in many poker chip cases, for holding a deck of cards, as shown in FIG. 5.

Whereas a single embodiment is herein shown and described, it should be understood that numerous variations can be made.

For example, whereas entry of a pair of cards automatically triggers the appearance of “pair” indicia on the screen, as a matter of convenience, this functionality is not essential.

As well, whereas in the exemplary embodiment, both suited and non-suited keys are provided, it will be understood that a single button could be used, with the device defaulting to one condition and being toggled to the other through a stroke of the single button.

Further, whereas a player number key is provided, this is also not essential. For example, activation of the suitedness key arrangement could automatically trigger the calculator to interpret further use of the card identification key arrangement as an indication of the number of players participating. As well, whereas the exemplary embodiment describes defaults to 2 players, the default condition could be any other number, or indeed, there could be no default condition at al.

Similarly, the calculate key could also be avoided, with the calculator automatically having recourse to the look-up table once all necessary data had been entered.

Yet further, whereas a particular sequence of keystrokes is herein suggested and described, the order is not essential and could be varied.

As well, whereas on/clear and power off buttons are shown, on/off functionality is, of course, unnecessary and could be omitted if, for example, the calculator was provided with a solar cell for power instead of a pre-charged battery.

Further, whereas a look-up table for 2-10 players is appended and used by the microprocessor of the exemplary embodiment, it will be appreciated that look-up tables of lesser or greater numbers of players could be utilized, and indeed, look-up tables could be avoided altogether in favor of alternative mechanisms of odds and rank calculation.

Accordingly, it should be understood that the invention is to be limited only by the accompanying claims, purposively construed.

Texas Hold'em Preflop Percentage Odds of Winning Chart with Hand Ranking (out of 169)

| | | | Number of Players | | | | | | | | | |
|---|---|---|---|---|---|---|---|---|---|---|---|---|
| Card 1 | Card 2 | Suit | 2 | Rank | 3 | Rank | 4 | Rank | 5 | Rank | 6 | Rank |
| A | A | Unsuited | 85.2% | 1 | 73.4% | 1 | 63.8% | 1 | 55.9% | 1 | 49.2% | 1 |
| K | K | Unsuited | 82.4% | 2 | 68.9% | 2 | 58.3% | 2 | 49.8% | 2 | 43.0% | 2 |
| Q | Q | Unsuited | 79.9% | 3 | 65.0% | 3 | 53.5% | 3 | 44.7% | 3 | 37.9% | 3 |
| J | J | Unsuited | 77.5% | 4 | 61.2% | 4 | 49.2% | 4 | 40.2% | 4 | 33.6% | 4 |
| 10 | 10 | Unsuited | 75.0% | 5 | 57.6% | 5 | 45.2% | 5 | 36.3% | 5 | 29.9% | 6 |
| 9 | 9 | Unsuited | 72.0% | 6 | 53.6% | 6 | 41.1% | 7 | 32.6% | 8 | 26.6% | 13 |
| 8 | 8 | Unsuited | 69.2% | 7 | 50.0% | 8 | 37.6% | 12 | 29.5% | 17 | 24.0% | 22 |
| 7 | 7 | Unsuited | 66.2% | 9 | 46.5% | 15 | 34.4% | 22 | 26.8% | 28 | 21.8% | 34 |
| 6 | 6 | Unsuited | 63.3% | 17 | 43.2% | 24 | 31.5% | 33 | 24.5% | 42 | 20.1% | 48 |
| 5 | 5 | Unsuited | 60.3% | 27 | 40.1% | 40 | 28.9% | 51 | 22.4% | 58 | 18.5% | 64 |
| 4 | 4 | Unsuited | 57.0% | 48 | 36.8% | 58 | 26.3% | 71 | 20.6% | 77 | 17.2% | 78 |
| 3 | 3 | Unsuited | 53.7% | 66 | 33.6% | 81 | 24.0% | 92 | 19.0% | 94 | 16.2% | 94 |
| 2 | 2 | Unsuited | 50.3% | 87 | 30.6% | 104 | 21.9% | 114 | 17.7% | 112 | 15.5% | 102 |
| A | K | Suited | 67.0% | 8 | 50.7% | 7 | 41.4% | 6 | 35.4% | 6 | 31.1% | 5 |
| A | Q | Suited | 66.2% | 10 | 49.4% | 9 | 39.9% | 8 | 33.7% | 7 | 29.3% | 7 |
| A | J | Suited | 65.4% | 11 | 48.2% | 10 | 38.4% | 10 | 32.2% | 11 | 27.9% | 9 |
| A | 10 | Suited | 64.6% | 13 | 47.1% | 13 | 37.2% | 13 | 31.0% | 13 | 26.7% | 12 |
| A | 9 | Suited | 62.8% | 18 | 44.6% | 19 | 34.5% | 20 | 28.3% | 22 | 24.1% | 21 |
| A | 8 | Suited | 61.9% | 21 | 43.5% | 23 | 33.5% | 26 | 27.3% | 25 | 23.2% | 25 |
| A | 7 | Suited | 61.0% | 24 | 42.4% | 27 | 32.4% | 29 | 26.4% | 31 | 22.4% | 30 |
| A | 6 | Suited | 59.9% | 31 | 41.1% | 34 | 31.3% | 35 | 25.4% | 36 | 21.6% | 37 |
| A | 5 | Suited | 59.9% | 30 | 41.4% | 32 | 31.7% | 32 | 26.0% | 33 | 22.2% | 33 |
| A | 4 | Suited | 59.0% | 35 | 40.5% | 36 | 31.0% | 38 | 25.3% | 37 | 21.7% | 35 |
| A | 3 | Suited | 58.2% | 38 | 39.7% | 41 | 30.2% | 42 | 24.8% | 40 | 21.2% | 40 |
| A | 2 | Suited | 57.4% | 46 | 38.8% | 47 | 29.4% | 47 | 24.1% | 45 | 20.6% | 43 |
| K | Q | Suited | 63.4% | 16 | 47.1% | 12 | 38.2% | 11 | 32.5% | 9 | 28.3% | 8 |
| K | J | Suited | 62.6% | 20 | 45.9% | 16 | 36.8% | 15 | 31.0% | 12 | 27.0% | 11 |
| K | 10 | Suited | 61.8% | 22 | 44.8% | 18 | 35.6% | 17 | 29.9% | 16 | 25.8% | 16 |
| K | 9 | Suited | 60.0% | 29 | 42.3% | 28 | 33.0% | 27 | 27.2% | 26 | 23.3% | 24 |
| K | 8 | Suited | 58.3% | 37 | 40.1% | 39 | 30.8% | 40 | 25.2% | 39 | 21.4% | 39 |
| K | 7 | Suited | 57.5% | 44 | 39.3% | 43 | 29.9% | 43 | 24.4% | 44 | 20.7% | 42 |
| K | 6 | Suited | 56.6% | 50 | 38.3% | 50 | 29.1% | 49 | 23.6% | 49 | 20.0% | 49 |
| K | 5 | Suited | 55.8% | 54 | 37.4% | 54 | 28.2% | 55 | 23.0% | 52 | 19.5% | 50 |
| K | 4 | Suited | 54.9% | 60 | 36.5% | 60 | 27.5% | 60 | 22.4% | 59 | 19.0% | 54 |
| K | 3 | Suited | 54.1% | 63 | 35.7% | 66 | 26.8% | 67 | 21.9% | 66 | 18.6% | 62 |
| K | 2 | Suited | 53.2% | 71 | 34.9% | 73 | 26.2% | 74 | 21.3% | 68 | 18.2% | 66 |
| Q | J | Suited | 60.2% | 28 | 44.2% | 22 | 35.7% | 16 | 30.2% | 15 | 26.2% | 14 |
| Q | 10 | Suited | 59.5% | 34 | 43.1% | 26 | 34.5% | 21 | 29.1% | 19 | 25.1% | 17 |
| Q | 9 | Suited | 57.7% | 43 | 40.6% | 35 | 31.9% | 31 | 26.4% | 30 | 22.6% | 28 |
| Q | 8 | Suited | 56.0% | 52 | 38.5% | 49 | 29.7% | 45 | 24.4% | 43 | 20.7% | 41 |
| Q | 7 | Suited | 54.3% | 61 | 36.5% | 61 | 27.7% | 58 | 22.5% | 54 | 19.1% | 53 |
| Q | 6 | Suited | 53.6% | 67 | 35.7% | 67 | 27.0% | 65 | 21.9% | 65 | 18.5% | 63 |
| Q | 5 | Suited | 52.8% | 72 | 34.9% | 74 | 26.3% | 72 | 21.3% | 69 | 18.0% | 68 |
| Q | 4 | Suited | 51.8% | 76 | 34.0% | 78 | 25.5% | 76 | 20.7% | 73 | 17.6% | 71 |
| Q | 3 | Suited | 51.0% | 82 | 33.2% | 84 | 24.9% | 86 | 20.2% | 84 | 17.2% | 79 |
| Q | 2 | Suited | 50.2% | 88 | 32.4% | 90 | 24.3% | 90 | 19.7% | 88 | 16.8% | 85 |
| J | 10 | Suited | 57.5% | 45 | 42.0% | 29 | 33.9% | 24 | 28.6% | 21 | 24.9% | 19 |
| J | 9 | Suited | 55.7% | 55 | 39.5% | 42 | 31.2% | 36 | 26.0% | 32 | 22.4% | 31 |
| J | 8 | Suited | 54.0% | 65 | 37.4% | 55 | 29.1% | 48 | 24.0% | 46 | 20.5% | 45 |
| J | 7 | Suited | 52.3% | 74 | 35.4% | 69 | 27.1% | 64 | 22.2% | 60 | 18.8% | 59 |
| J | 6 | Suited | 50.6% | 85 | 33.4% | 83 | 25.2% | 81 | 20.5% | 78 | 17.3% | 77 |
| J | 5 | Suited | 50.0% | 90 | 32.7% | 87 | 24.7% | 88 | 20.0% | 86 | 16.9% | 83 |
| J | 4 | Suited | 49.1% | 95 | 31.9% | 95 | 24.0% | 91 | 19.4% | 91 | 16.4% | 91 |
| J | 3 | Suited | 48.3% | 97 | 31.1% | 101 | 23.4% | 98 | 18.9% | 95 | 16.0% | 95 |
| J | 2 | Suited | 47.4% | 104 | 30.3% | 107 | 22.7% | 108 | 18.4% | 101 | 15.7% | 100 |
| 10 | 9 | Suited | 54.0% | 64 | 38.7% | 48 | 30.9% | 39 | 25.9% | 34 | 22.4% | 29 |
| 10 | 8 | Suited | 52.3% | 73 | 36.7% | 59 | 28.9% | 50 | 24.0% | 47 | 20.6% | 44 |
| 10 | 7 | Suited | 50.6% | 84 | 34.7% | 75 | 26.9% | 66 | 22.1% | 61 | 18.9% | 57 |
| 10 | 6 | Suited | 48.9% | 96 | 32.7% | 89 | 25.0% | 84 | 20.4% | 80 | 17.4% | 75 |
| 10 | 5 | Suited | 47.2% | 106 | 30.8% | 102 | 23.2% | 99 | 18.9% | 98 | 16.0% | 96 |
| 10 | 4 | Suited | 46.5% | 108 | 30.2% | 110 | 22.7% | 107 | 18.4% | 103 | 15.6% | 101 |
| 10 | 3 | Suited | 45.7% | 114 | 29.4% | 115 | 22.1% | 113 | 17.9% | 109 | 15.2% | 107 |
| 10 | 2 | Suited | 44.8% | 118 | 28.7% | 119 | 21.5% | 118 | 17.5% | 116 | 14.9% | 112 |
| 9 | 8 | Suited | 50.8% | 83 | 36.0% | 64 | 28.5% | 53 | 23.6% | 48 | 20.3% | 46 |
| 9 | 7 | Suited | 49.1% | 94 | 34.1% | 77 | 26.7% | 68 | 22.0% | 63 | 18.8% | 60 |
| 9 | 6 | Suited | 47.4% | 103 | 32.2% | 92 | 24.8% | 87 | 20.4% | 82 | 17.3% | 76 |
| 9 | 5 | Suited | 45.7% | 113 | 30.2% | 109 | 23.0% | 104 | 18.8% | 99 | 15.9% | 97 |
| 9 | 4 | Suited | 43.9% | 123 | 28.4% | 125 | 21.3% | 121 | 17.3% | 117 | 14.6% | 116 |
| 9 | 3 | Suited | 43.3% | 126 | 27.8% | 129 | 20.9% | 126 | 16.9% | 122 | 14.3% | 120 |
| 9 | 2 | Suited | 42.4% | 132 | 27.1% | 133 | 20.3% | 131 | 16.4% | 129 | 13.9% | 124 |
| 8 | 7 | Suited | 47.9% | 100 | 33.8% | 80 | 26.7% | 69 | 22.1% | 62 | 19.0% | 55 |
| 8 | 6 | Suited | 46.2% | 110 | 31.9% | 94 | 24.9% | 85 | 20.6% | 76 | 17.7% | 70 |
| 8 | 5 | Suited | 44.6% | 119 | 30.1% | 112 | 23.2% | 102 | 19.0% | 93 | 16.3% | 93 |
| 8 | 4 | Suited | 42.7% | 129 | 28.2% | 128 | 21.5% | 117 | 17.5% | 115 | 14.9% | 111 |
| 8 | 3 | Suited | 40.9% | 139 | 26.3% | 143 | 19.8% | 136 | 16.0% | 132 | 13.6% | 128 |
| 8 | 2 | Suited | 40.3% | 142 | 25.8% | 144 | 19.4% | 139 | 15.7% | 136 | 13.3% | 133 |
| 7 | 6 | Suited | 45.4% | 115 | 31.9% | 97 | 25.1% | 82 | 20.8% | 72 | 17.9% | 69 |
| 7 | 5 | Suited | 43.7% | 124 | 30.1% | 111 | 23.5% | 96 | 19.4% | 92 | 16.7% | 87 |
| 7 | 4 | Suited | 41.9% | 134 | 28.3% | 126 | 21.7% | 115 | 17.9% | 111 | 15.3% | 103 |
| 7 | 3 | Suited | 40.0% | 144 | 26.4% | 142 | 20.1% | 133 | 16.4% | 130 | 14.0% | 123 |
| 7 | 2 | Suited | 38.1% | 153 | 24.6% | 152 | 18.4% | 149 | 15.0% | 145 | 12.8% | 140 |
| 6 | 5 | Suited | 43.1% | 128 | 30.3% | 108 | 23.7% | 94 | 19.7% | 89 | 17.1% | 80 |
| 6 | 4 | Suited | 41.3% | 138 | 28.5% | 122 | 22.2% | 111 | 18.3% | 105 | 15.9% | 99 |
| 6 | 3 | Suited | 39.5% | 147 | 26.7% | 135 | 20.5% | 129 | 16.9% | 123 | 14.6% | 117 |
| 6 | 2 | Suited | 37.7% | 156 | 24.8% | 148 | 18.8% | 146 | 15.4% | 140 | 13.3% | 134 |
| 5 | 4 | Suited | 41.5% | 136 | 29.0% | 118 | 22.7% | 109 | 18.9% | 96 | 16.5% | 90 |
| 5 | 3 | Suited | 39.7% | 146 | 27.3% | 131 | 21.2% | 124 | 17.6% | 114 | 15.3% | 104 |
| 5 | 2 | Suited | 37.8% | 155 | 25.5% | 146 | 19.5% | 138 | 16.2% | 131 | 14.0% | 122 |
| 4 | 3 | Suited | 38.6% | 150 | 26.4% | 140 | 20.4% | 130 | 16.9% | 121 | 14.7% | 115 |
| 4 | 2 | Suited | 36.8% | 159 | 24.7% | 151 | 18.9% | 144 | 15.7% | 137 | 13.6% | 129 |
| 3 | 2 | Suited | 36.0% | 163 | 23.8% | 157 | 18.2% | 151 | 15.0% | 144 | 13.1% | 137 |
| A | K | Unsuited | 65.3% | 12 | 48.2% | 11 | 38.5% | 9 | 32.3% | 10 | 27.9% | 10 |
| A | Q | Unsuited | 64.4% | 14 | 46.8% | 14 | 36.8% | 14 | 30.4% | 14 | 25.9% | 15 |
| A | J | Unsuited | 63.6% | 15 | 45.5% | 17 | 35.3% | 18 | 28.8% | 20 | 24.3% | 20 |
| A | 10 | Unsuited | 62.7% | 19 | 44.3% | 21 | 34.0% | 23 | 27.5% | 24 | 23.0% | 26 |
| A | 9 | Unsuited | 60.8% | 25 | 41.6% | 31 | 31.0% | 37 | 24.6% | 41 | 20.2% | 47 |
| A | 8 | Unsuited | 59.9% | 32 | 40.5% | 37 | 29.9% | 44 | 23.5% | 51 | 19.2% | 52 |
| A | 7 | Unsuited | 58.9% | 36 | 39.2% | 45 | 28.8% | 52 | 22.5% | 57 | 18.3% | 65 |
| A | 6 | Unsuited | 57.7% | 42 | 37.9% | 52 | 27.5% | 61 | 21.4% | 67 | 17.4% | 73 |
| A | 5 | Unsuited | 57.7% | 41 | 38.2% | 51 | 28.0% | 56 | 22.0% | 64 | 18.1% | 67 |
| A | 4 | Unsuited | 56.7% | 49 | 37.2% | 56 | 27.1% | 62 | 21.3% | 70 | 17.5% | 72 |
| A | 3 | Unsuited | 55.8% | 53 | 36.3% | 63 | 26.3% | 70 | 20.6% | 74 | 16.9% | 81 |
| A | 2 | Unsuited | 54.9% | 59 | 35.2% | 71 | 25.4% | 78 | 19.9% | 87 | 16.3% | 92 |
| K | Q | Unsuited | 61.5% | 23 | 44.4% | 20 | 35.2% | 19 | 29.3% | 18 | 25.0% | 18 |
| K | J | Unsuited | 60.6% | 26 | 43.1% | 25 | 33.7% | 25 | 27.7% | 23 | 23.5% | 23 |
| K | 10 | Unsuited | 59.7% | 33 | 41.9% | 30 | 32.4% | 30 | 26.4% | 29 | 22.2% | 32 |
| K | 9 | Unsuited | 57.8% | 40 | 39.2% | 44 | 29.5% | 46 | 23.5% | 50 | 19.4% | 51 |
| K | 8 | Unsuited | 56.0% | 51 | 36.9% | 57 | 27.1% | 63 | 21.3% | 71 | 17.4% | 74 |
| K | 7 | Unsuited | 55.2% | 58 | 36.0% | 65 | 26.2% | 73 | 20.4% | 79 | 16.6% | 89 |
| K | 6 | Unsuited | 54.2% | 62 | 34.9% | 72 | 25.2% | 80 | 19.6% | 90 | 15.9% | 98 |
| K | 5 | Unsuited | 53.3% | 69 | 34.0% | 79 | 24.4% | 89 | 18.9% | 97 | 15.3% | 105 |
| K | 4 | Unsuited | 52.3% | 75 | 33.0% | 86 | 23.6% | 95 | 18.2% | 108 | 14.8% | 114 |
| K | 3 | Unsuited | 51.4% | 80 | 32.1% | 93 | 22.8% | 106 | 17.6% | 113 | 14.3% | 119 |
| K | 2 | Unsuited | 50.5% | 86 | 31.2% | 100 | 22.1% | 112 | 17.0% | 120 | 13.9% | 126 |
| Q | J | Unsuited | 58.1% | 39 | 41.3% | 33 | 32.6% | 28 | 26.9% | 27 | 22.9% | 27 |
| Q | 10 | Unsuited | 57.3% | 47 | 40.2% | 38 | 31.3% | 34 | 25.7% | 35 | 21.7% | 36 |
| Q | 9 | Unsuited | 55.3% | 56 | 37.5% | 53 | 28.4% | 54 | 22.8% | 53 | 18.9% | 58 |
| Q | 8 | Unsuited | 53.6% | 68 | 35.3% | 70 | 26.1% | 75 | 20.6% | 75 | 16.8% | 84 |
| Q | 7 | Unsuited | 51.8% | 77 | 33.1% | 85 | 23.9% | 93 | 18.6% | 100 | 15.0% | 110 |
| Q | 6 | Unsuited | 51.1% | 81 | 32.2% | 91 | 23.2% | 101 | 17.9% | 110 | 14.4% | 118 |
| Q | 5 | Unsuited | 50.1% | 89 | 31.3% | 98 | 22.3% | 110 | 17.2% | 118 | 13.9% | 125 |
| Q | 4 | Unsuited | 49.1% | 93 | 30.4% | 106 | 21.6% | 116 | 16.6% | 125 | 13.4% | 131 |
| Q | 3 | Unsuited | 48.2% | 98 | 29.5% | 114 | 20.8% | 127 | 16.0% | 133 | 12.9% | 138 |
| Q | 2 | Unsuited | 47.3% | 105 | 28.6% | 120 | 20.1% | 132 | 15.4% | 139 | 12.5% | 143 |
| J | 10 | Unsuited | 55.3% | 57 | 39.0% | 46 | 30.7% | 41 | 25.3% | 38 | 21.5% | 38 |
| J | 9 | Unsuited | 53.3% | 70 | 36.4% | 62 | 27.8% | 57 | 22.5% | 56 | 18.7% | 61 |
| J | 8 | Unsuited | 51.5% | 79 | 34.1% | 76 | 25.5% | 77 | 20.3% | 83 | 16.7% | 86 |
| J | 7 | Unsuited | 49.7% | 92 | 31.9% | 96 | 23.4% | 97 | 18.3% | 107 | 14.9% | 113 |
| J | 6 | Unsuited | 47.9% | 102 | 29.8% | 113 | 21.4% | 120 | 16.5% | 128 | 13.2% | 136 |
| J | 5 | Unsuited | 47.2% | 107 | 29.1% | 117 | 20.7% | 128 | 15.9% | 134 | 12.8% | 141 |
| J | 4 | Unsuited | 46.2% | 111 | 28.2% | 127 | 20.0% | 134 | 15.3% | 141 | 12.3% | 145 |
| J | 3 | Unsuited | 45.3% | 116 | 27.3% | 130 | 19.3% | 142 | 14.7% | 148 | 11.8% | 149 |
| J | 2 | Unsuited | 44.3% | 121 | 26.5% | 138 | 18.6% | 148 | 14.2% | 151 | 11.4% | 151 |
| 10 | 9 | Unsuited | 51.5% | 78 | 35.7% | 68 | 27.6% | 59 | 22.5% | 55 | 18.9% | 56 |
| 10 | 8 | Unsuited | 49.7% | 91 | 33.4% | 82 | 25.4% | 79 | 20.4% | 81 | 16.9% | 82 |
| 10 | 7 | Unsuited | 47.9% | 101 | 31.2% | 99 | 23.2% | 100 | 18.4% | 104 | 15.1% | 109 |
| 10 | 6 | Unsuited | 46.1% | 112 | 29.2% | 116 | 21.2% | 123 | 16.5% | 126 | 13.4% | 132 |
| 10 | 5 | Unsuited | 44.2% | 122 | 27.1% | 132 | 19.3% | 141 | 14.8% | 146 | 11.9% | 148 |
| 10 | 4 | Unsuited | 43.5% | 125 | 26.4% | 139 | 18.7% | 147 | 14.3% | 150 | 11.5% | 150 |
| 10 | 3 | Unsuited | 42.6% | 131 | 25.6% | 145 | 18.0% | 152 | 13.8% | 153 | 11.0% | 154 |
| 10 | 2 | Unsuited | 41.7% | 135 | 24.7% | 150 | 17.3% | 155 | 13.2% | 156 | 10.6% | 157 |
| 9 | 8 | Unsuited | 48.1% | 99 | 32.7% | 88 | 25.0% | 83 | 20.1% | 85 | 16.6% | 88 |
| 9 | 7 | Unsuited | 46.3% | 109 | 30.7% | 103 | 23.0% | 105 | 18.3% | 106 | 15.1% | 108 |
| 9 | 6 | Unsuited | 44.5% | 120 | 28.6% | 121 | 21.1% | 125 | 16.5% | 127 | 13.5% | 130 |
| 9 | 5 | Unsuited | 42.6% | 130 | 26.6% | 136 | 19.1% | 143 | 14.8% | 147 | 11.9% | 147 |
| 9 | 4 | Unsuited | 40.7% | 140 | 24.5% | 153 | 17.3% | 156 | 13.2% | 157 | 10.5% | 159 |
| 9 | 3 | Unsuited | 40.0% | 143 | 23.9% | 156 | 16.8% | 158 | 12.7% | 160 | 10.1% | 160 |
| 9 | 2 | Unsuited | 39.1% | 149 | 23.1% | 159 | 16.1% | 161 | 12.2% | 162 | 9.7% | 163 |
| 8 | 7 | Unsuited | 45.1% | 117 | 30.4% | 105 | 23.1% | 103 | 18.4% | 102 | 15.2% | 106 |
| 8 | 6 | Unsuited | 43.2% | 127 | 28.4% | 124 | 21.2% | 122 | 16.8% | 124 | 13.8% | 127 |
| 8 | 5 | Unsuited | 41.4% | 137 | 26.4% | 141 | 19.3% | 140 | 15.1% | 142 | 12.3% | 144 |
| 8 | 4 | Unsuited | 39.5% | 148 | 24.4% | 155 | 17.5% | 154 | 13.4% | 155 | 10.8% | 155 |
| 8 | 3 | Unsuited | 37.5% | 157 | 22.4% | 163 | 15.7% | 163 | 11.9% | 164 | 9.5% | 165 |
| 8 | 2 | Unsuited | 36.8% | 158 | 21.8% | 164 | 15.2% | 165 | 11.4% | 166 | 9.1% | 166 |
| 7 | 6 | Unsuited | 42.3% | 133 | 28.4% | 123 | 21.4% | 119 | 17.0% | 119 | 14.1% | 121 |
| 7 | 5 | Unsuited | 40.5% | 141 | 26.5% | 137 | 19.6% | 137 | 15.5% | 138 | 12.8% | 139 |
| 7 | 4 | Unsuited | 38.5% | 151 | 24.5% | 154 | 17.8% | 153 | 13.9% | 152 | 11.4% | 153 |
| 7 | 3 | Unsuited | 36.6% | 160 | 22.5% | 162 | 16.0% | 162 | 12.3% | 161 | 9.9% | 162 |
| 7 | 2 | Unsuited | 34.6% | 165 | 20.5% | 168 | 14.2% | 168 | 10.8% | 169 | 8.6% | 169 |
| 6 | 5 | Unsuited | 40.0% | 145 | 26.7% | 134 | 20.0% | 135 | 15.9% | 135 | 13.2% | 135 |
| 6 | 4 | Unsuited | 38.0% | 154 | 24.8% | 149 | 18.3% | 150 | 14.4% | 149 | 12.0% | 146 |
| 6 | 3 | Unsuited | 36.1% | 162 | 22.8% | 160 | 16.5% | 159 | 12.8% | 159 | 10.5% | 158 |
| 6 | 2 | Unsuited | 34.1% | 167 | 20.8% | 166 | 14.7% | 167 | 11.2% | 167 | 9.1% | 167 |
| 5 | 4 | Unsuited | 38.2% | 152 | 25.3% | 147 | 18.9% | 145 | 15.0% | 143 | 12.6% | 142 |
| 5 | 3 | Unsuited | 36.3% | 161 | 23.5% | 158 | 17.2% | 157 | 13.6% | 154 | 11.4% | 152 |
| 5 | 2 | Unsuited | 34.3% | 166 | 21.5% | 165 | 15.4% | 164 | 12.1% | 163 | 10.0% | 161 |
| 4 | 3 | Unsuited | 35.1% | 164 | 22.5% | 161 | 16.4% | 160 | 12.9% | 158 | 10.8% | 156 |
| 4 | 2 | Unsuited | 33.2% | 168 | 20.7% | 167 | 14.7% | 166 | 11.5% | 165 | 9.5% | 164 |
| 3 | 2 | Unsuited | 32.3% | 169 | 19.7% | 169 | 14.0% | 169 | 10.8% | 168 | 9.0% | 168 |

| | | | Number of Players | | | | | | | |
|---|---|---|---|---|---|---|---|---|---|---|
| Card 1 | Card 2 | Suit | 7 | Rank | 8 | Rank | 9 | Rank | 10 | Rank |
| A | A | Unsuited | 43.5% | 1 | 38.7% | 1 | 34.6% | 1 | 31.1% | 1 |
| K | K | Unsuited | 37.4% | 2 | 32.9% | 2 | 29.2% | 2 | 26.1% | 2 |
| Q | Q | Unsuited | 32.5% | 3 | 28.3% | 3 | 24.9% | 3 | 22.2% | 3 |
| J | J | Unsuited | 28.5% | 4 | 24.6% | 5 | 21.7% | 5 | 19.3% | 5 |
| 10 | 10 | Unsuited | 25.2% | 7 | 21.7% | 9 | 19.1% | 11 | 17.2% | 13 |
| 9 | 9 | Unsuited | 22.4% | 16 | 19.4% | 18 | 17.2% | 18 | 15.6% | 17 |
| 8 | 8 | Unsuited | 20.3% | 23 | 17.7% | 26 | 15.8% | 27 | 14.5% | 26 |
| 7 | 7 | Unsuited | 18.6% | 39 | 16.4% | 38 | 14.8% | 37 | 13.6% | 35 |
| 6 | 6 | Unsuited | 17.3% | 48 | 15.3% | 48 | 14.0% | 47 | 13.0% | 46 |
| 5 | 5 | Unsuited | 16.1% | 62 | 14.4% | 58 | 13.3% | 55 | 12.4% | 52 |
| 4 | 4 | Unsuited | 15.2% | 71 | 13.9% | 66 | 12.9% | 60 | 12.1% | 56 |
| 3 | 3 | Unsuited | 14.6% | 84 | 13.5% | 74 | 12.7% | 65 | 12.0% | 60 |
| 2 | 2 | Unsuited | 14.1% | 93 | 13.2% | 79 | 12.5% | 68 | 11.9% | 62 |
| A | K | Suited | 27.7% | 5 | 25.0% | 4 | 22.6% | 4 | 20.7% | 4 |
| A | Q | Suited | 26.0% | 6 | 23.3% | 6 | 21.1% | 6 | 19.2% | 6 |
| A | J | Suited | 24.6% | 9 | 22.0% | 8 | 19.9% | 8 | 18.2% | 8 |
| A | 10 | Suited | 23.5% | 12 | 21.0% | 12 | 19.0% | 12 | 17.3% | 10 |
| A | 9 | Suited | 21.1% | 20 | 18.7% | 20 | 16.9% | 20 | 15.4% | 19 |
| A | 8 | Suited | 20.2% | 25 | 18.0% | 23 | 16.2% | 22 | 14.7% | 23 |
| A | 7 | Suited | 19.5% | 31 | 17.3% | 30 | 15.7% | 29 | 14.3% | 29 |
| A | 6 | Suited | 18.9% | 35 | 16.8% | 34 | 15.2% | 33 | 13.9% | 33 |
| A | 5 | Suited | 19.5% | 32 | 17.4% | 29 | 15.8% | 28 | 14.4% | 27 |
| A | 4 | Suited | 19.0% | 34 | 17.1% | 33 | 15.5% | 31 | 14.2% | 30 |
| A | 3 | Suited | 18.6% | 37 | 16.7% | 35 | 15.2% | 34 | 14.0% | 31 |
| A | 2 | Suited | 18.1% | 41 | 16.3% | 41 | 14.8% | 38 | 13.6% | 36 |
| K | Q | Suited | 25.1% | 8 | 22.5% | 7 | 20.4% | 7 | 18.6% | 7 |
| K | J | Suited | 23.8% | 11 | 21.3% | 11 | 19.3% | 9 | 17.6% | 9 |
| K | 10 | Suited | 22.8% | 14 | 20.4% | 14 | 18.5% | 14 | 16.9% | 14 |
| K | 9 | Suited | 20.3% | 22 | 18.1% | 22 | 16.3% | 21 | 14.9% | 21 |
| K | 8 | Suited | 18.6% | 38 | 16.5% | 37 | 14.9% | 36 | 13.6% | 37 |
| K | 7 | Suited | 18.0% | 44 | 16.0% | 45 | 14.4% | 46 | 13.1% | 43 |
| K | 6 | Suited | 17.5% | 47 | 15.5% | 47 | 14.0% | 48 | 12.8% | 48 |
| K | 5 | Suited | 17.0% | 50 | 15.1% | 49 | 13.7% | 50 | 12.5% | 50 |
| K | 4 | Suited | 16.6% | 52 | 14.8% | 52 | 13.4% | 53 | 12.3% | 54 |
| K | 3 | Suited | 16.3% | 58 | 14.6% | 57 | 13.2% | 57 | 12.1% | 57 |
| K | 2 | Suited | 16.0% | 64 | 14.3% | 60 | 13.0% | 59 | 12.0% | 61 |
| Q | J | Suited | 23.2% | 13 | 20.8% | 13 | 18.8% | 13 | 17.3% | 11 |
| Q | 10 | Suited | 22.2% | 17 | 19.9% | 15 | 18.1% | 15 | 16.6% | 15 |
| Q | 9 | Suited | 19.8% | 26 | 17.6% | 27 | 15.9% | 25 | 14.5% | 25 |
| Q | 8 | Suited | 18.1% | 43 | 16.1% | 43 | 14.5% | 43 | 13.2% | 42 |
| Q | 7 | Suited | 16.6% | 53 | 14.7% | 54 | 13.3% | 54 | 12.1% | 58 |
| Q | 6 | Suited | 16.1% | 61 | 14.3% | 61 | 12.9% | 61 | 11.7% | 65 |
| Q | 5 | Suited | 15.7% | 67 | 13.9% | 65 | 12.6% | 66 | 11.5% | 67 |
| Q | 4 | Suited | 15.3% | 69 | 13.7% | 71 | 12.4% | 71 | 11.3% | 71 |
| Q | 3 | Suited | 15.0% | 77 | 13.4% | 76 | 12.2% | 76 | 11.1% | 74 |
| Q | 2 | Suited | 14.7% | 81 | 13.2% | 80 | 12.0% | 80 | 11.0% | 77 |
| J | 10 | Suited | 22.0% | 18 | 19.8% | 16 | 18.0% | 16 | 16.5% | 16 |
| J | 9 | Suited | 19.6% | 30 | 17.5% | 28 | 15.9% | 26 | 14.6% | 24 |
| J | 8 | Suited | 17.9% | 45 | 16.0% | 44 | 14.5% | 44 | 13.2% | 41 |
| J | 7 | Suited | 16.4% | 57 | 14.6% | 56 | 13.2% | 58 | 12.0% | 59 |
| J | 6 | Suited | 15.1% | 76 | 13.4% | 78 | 12.0% | 78 | 11.0% | 76 |
| J | 5 | Suited | 14.7% | 82 | 13.1% | 83 | 11.8% | 82 | 10.8% | 82 |
| J | 4 | Suited | 14.3% | 87 | 12.8% | 86 | 11.6% | 85 | 10.6% | 84 |
| J | 3 | Suited | 14.0% | 95 | 12.5% | 89 | 11.4% | 87 | 10.4% | 87 |
| J | 2 | Suited | 13.8% | 100 | 12.3% | 97 | 11.2% | 92 | 10.3% | 90 |
| 10 | 9 | Suited | 19.7% | 28 | 17.7% | 24 | 16.1% | 23 | 14.8% | 22 |
| 10 | 8 | Suited | 18.1% | 42 | 16.2% | 42 | 14.7% | 39 | 13.6% | 38 |
| 10 | 7 | Suited | 16.6% | 55 | 14.8% | 53 | 13.4% | 52 | 12.3% | 53 |
| 10 | 6 | Suited | 15.2% | 75 | 13.5% | 75 | 12.2% | 74 | 11.2% | 72 |
| 10 | 5 | Suited | 13.9% | 96 | 12.4% | 94 | 11.2% | 91 | 10.3% | 91 |
| 10 | 4 | Suited | 13.6% | 102 | 12.1% | 100 | 11.0% | 96 | 10.0% | 94 |
| 10 | 3 | Suited | 13.3% | 104 | 11.9% | 103 | 10.8% | 101 | 9.9% | 98 |
| 10 | 2 | Suited | 13.0% | 109 | 11.6% | 108 | 10.6% | 105 | 9.7% | 102 |
| 9 | 8 | Suited | 17.8% | 46 | 16.0% | 46 | 14.5% | 41 | 13.4% | 39 |
| 9 | 7 | Suited | 16.6% | 54 | 14.9% | 51 | 13.5% | 51 | 12.5% | 51 |
| 9 | 6 | Suited | 15.2% | 73 | 13.6% | 72 | 12.4% | 70 | 11.4% | 69 |
| 9 | 5 | Suited | 13.9% | 97 | 12.4% | 93 | 11.3% | 89 | 10.3% | 89 |
| 9 | 4 | Suited | 12.7% | 113 | 11.4% | 111 | 10.3% | 110 | 9.4% | 106 |
| 9 | 3 | Suited | 12.5% | 117 | 11.1% | 115 | 10.1% | 114 | 9.3% | 110 |
| 9 | 2 | Suited | 12.2% | 122 | 10.9% | 119 | 9.9% | 115 | 9.1% | 115 |
| 8 | 7 | Suited | 16.7% | 51 | 15.0% | 50 | 13.8% | 49 | 12.8% | 49 |
| 8 | 6 | Suited | 15.6% | 68 | 14.0% | 64 | 12.8% | 62 | 11.9% | 63 |
| 8 | 5 | Suited | 14.3% | 89 | 12.9% | 84 | 11.8% | 83 | 10.9% | 78 |
| 8 | 4 | Suited | 13.1% | 107 | 11.7% | 107 | 10.7% | 103 | 9.8% | 101 |
| 8 | 3 | Suited | 11.9% | 126 | 10.7% | 121 | 9.7% | 120 | 8.9% | 118 |
| 8 | 2 | Suited | 11.7% | 130 | 10.5% | 127 | 9.5% | 123 | 8.8% | 120 |
| 7 | 6 | Suited | 15.9% | 66 | 14.4% | 59 | 13.2% | 56 | 12.3% | 55 |
| 7 | 5 | Suited | 14.8% | 78 | 13.4% | 77 | 12.3% | 72 | 11.5% | 68 |
| 7 | 4 | Suited | 13.6% | 103 | 12.3% | 98 | 11.3% | 90 | 10.4% | 86 |
| 7 | 3 | Suited | 12.4% | 119 | 11.1% | 114 | 10.2% | 113 | 9.4% | 109 |
| 7 | 2 | Suited | 11.3% | 135 | 10.1% | 132 | 9.3% | 125 | 8.5% | 124 |
| 6 | 5 | Suited | 15.2% | 74 | 13.8% | 68 | 12.8% | 63 | 11.9% | 64 |
| 6 | 4 | Suited | 14.2% | 91 | 12.9% | 85 | 11.9% | 81 | 11.1% | 75 |
| 6 | 3 | Suited | 13.0% | 110 | 11.8% | 106 | 10.8% | 100 | 10.1% | 93 |
| 6 | 2 | Suited | 11.7% | 128 | 10.7% | 123 | 9.8% | 118 | 9.0% | 116 |
| 5 | 4 | Suited | 14.8% | 79 | 13.5% | 73 | 12.5% | 69 | 11.6% | 66 |
| 5 | 3 | Suited | 13.7% | 101 | 12.6% | 88 | 11.6% | 84 | 10.9% | 80 |
| 5 | 2 | Suited | 12.6% | 115 | 11.5% | 109 | 10.6% | 106 | 9.9% | 99 |
| 4 | 3 | Suited | 13.2% | 106 | 12.1% | 102 | 11.2% | 94 | 10.4% | 88 |
| 4 | 2 | Suited | 12.2% | 121 | 11.2% | 113 | 10.3% | 109 | 9.6% | 103 |
| 3 | 2 | Suited | 11.7% | 129 | 10.7% | 122 | 9.9% | 116 | 9.2% | 114 |
| A | K | Unsuited | 24.4% | 10 | 21.6% | 10 | 19.2% | 10 | 17.2% | 12 |
| A | Q | Unsuited | 22.4% | 15 | 19.7% | 17 | 17.5% | 17 | 15.5% | 18 |
| A | J | Unsuited | 20.9% | 21 | 18.3% | 21 | 16.1% | 24 | 14.3% | 28 |
| A | 10 | Unsuited | 19.7% | 29 | 17.1% | 32 | 15.1% | 35 | 13.3% | 40 |
| A | 9 | Unsuited | 17.1% | 49 | 14.6% | 55 | 12.7% | 64 | 11.2% | 73 |
| A | 8 | Unsuited | 16.1% | 60 | 13.8% | 70 | 12.0% | 79 | 10.5% | 85 |
| A | 7 | Unsuited | 15.3% | 70 | 13.1% | 82 | 11.3% | 88 | 10.0% | 95 |
| A | 6 | Unsuited | 14.6% | 83 | 12.5% | 90 | 10.9% | 98 | 9.6% | 105 |
| A | 5 | Unsuited | 15.2% | 72 | 13.1% | 81 | 11.5% | 86 | 10.1% | 92 |
| A | 4 | Unsuited | 14.8% | 80 | 12.7% | 87 | 11.2% | 93 | 9.9% | 97 |
| A | 3 | Unsuited | 14.3% | 88 | 12.4% | 95 | 10.8% | 99 | 9.6% | 104 |
| A | 2 | Unsuited | 13.8% | 99 | 11.9% | 104 | 10.4% | 108 | 9.2% | 113 |
| K | Q | Unsuited | 21.8% | 19 | 19.1% | 19 | 16.9% | 19 | 15.1% | 20 |
| K | J | Unsuited | 20.3% | 24 | 17.7% | 25 | 15.6% | 30 | 13.9% | 32 |
| K | 10 | Unsuited | 19.1% | 33 | 16.7% | 36 | 14.7% | 40 | 13.1% | 44 |
| K | 9 | Unsuited | 16.5% | 56 | 14.1% | 63 | 12.3% | 73 | 10.8% | 81 |
| K | 8 | Unsuited | 14.6% | 85 | 12.4% | 92 | 10.8% | 102 | 9.4% | 107 |
| K | 7 | Unsuited | 13.9% | 98 | 11.8% | 105 | 10.2% | 111 | 8.9% | 117 |
| K | 6 | Unsuited | 13.3% | 105 | 11.3% | 112 | 9.8% | 119 | 8.5% | 123 |
| K | 5 | Unsuited | 12.8% | 112 | 10.9% | 118 | 9.4% | 124 | 8.2% | 127 |
| K | 4 | Unsuited | 12.3% | 120 | 10.5% | 126 | 9.1% | 130 | 8.0% | 130 |
| K | 3 | Unsuited | 12.0% | 125 | 10.2% | 129 | 8.9% | 132 | 7.8% | 133 |
| K | 2 | Unsuited | 11.6% | 131 | 9.9% | 133 | 8.7% | 135 | 7.7% | 135 |
| Q | J | Unsuited | 19.8% | 27 | 17.3% | 31 | 15.3% | 32 | 13.7% | 34 |
| Q | 10 | Unsuited | 18.7% | 36 | 16.3% | 40 | 14.4% | 45 | 12.9% | 47 |
| Q | 9 | Unsuited | 16.0% | 63 | 13.8% | 69 | 12.1% | 77 | 10.7% | 83 |
| Q | 8 | Unsuited | 14.1% | 92 | 12.1% | 101 | 10.5% | 107 | 9.2% | 111 |
| Q | 7 | Unsuited | 12.5% | 116 | 10.6% | 124 | 9.2% | 129 | 8.0% | 131 |
| Q | 6 | Unsuited | 12.0% | 124 | 10.1% | 130 | 8.7% | 133 | 7.6% | 136 |
| Q | 5 | Unsuited | 11.5% | 132 | 9.8% | 136 | 8.4% | 137 | 7.4% | 138 |
| Q | 4 | Unsuited | 11.1% | 137 | 9.4% | 139 | 8.2% | 140 | 7.1% | 142 |
| Q | 3 | Unsuited | 10.8% | 141 | 9.2% | 141 | 7.9% | 144 | 7.0% | 144 |
| Q | 2 | Unsuited | 10.4% | 144 | 8.9% | 145 | 7.7% | 145 | 6.8% | 147 |
| J | 10 | Unsuited | 18.6% | 40 | 16.3% | 39 | 14.5% | 42 | 13.1% | 45 |
| J | 9 | Unsuited | 16.0% | 65 | 13.9% | 67 | 12.2% | 75 | 10.9% | 79 |
| J | 8 | Unsuited | 14.1% | 94 | 12.1% | 99 | 10.6% | 104 | 9.4% | 108 |
| J | 7 | Unsuited | 12.4% | 118 | 10.6% | 125 | 9.2% | 126 | 8.1% | 129 |
| J | 6 | Unsuited | 11.0% | 140 | 9.3% | 140 | 8.0% | 143 | 7.0% | 143 |
| J | 5 | Unsuited | 10.6% | 142 | 8.9% | 144 | 7.7% | 146 | 6.8% | 148 |
| J | 4 | Unsuited | 10.2% | 146 | 8.6% | 147 | 7.5% | 149 | 6.5% | 150 |
| J | 3 | Unsuited | 9.8% | 150 | 8.4% | 151 | 7.2% | 152 | 6.4% | 152 |
| J | 2 | Unsuited | 9.5% | 152 | 8.1% | 153 | 7.0% | 154 | 6.2% | 155 |
| 10 | 9 | Unsuited | 16.2% | 59 | 14.2% | 62 | 12.6% | 67 | 11.3% | 70 |
| 10 | 8 | Unsuited | 14.4% | 86 | 12.5% | 91 | 11.1% | 95 | 9.9% | 96 |
| 10 | 7 | Unsuited | 12.7% | 114 | 11.0% | 117 | 9.6% | 121 | 8.6% | 122 |
| 10 | 6 | Unsuited | 11.2% | 136 | 9.6% | 138 | 8.3% | 138 | 7.4% | 139 |
| 10 | 5 | Unsuited | 9.9% | 149 | 8.4% | 150 | 7.2% | 151 | 6.4% | 153 |
| 10 | 4 | Unsuited | 9.5% | 153 | 8.1% | 154 | 7.0% | 155 | 6.1% | 156 |
| 10 | 3 | Unsuited | 9.1% | 155 | 7.8% | 157 | 6.8% | 158 | 6.0% | 159 |
| 10 | 2 | Unsuited | 8.8% | 158 | 7.6% | 159 | 6.6% | 160 | 5.8% | 160 |
| 9 | 8 | Unsuited | 14.2% | 90 | 12.3% | 96 | 10.9% | 97 | 9.8% | 100 |
| 9 | 7 | Unsuited | 12.8% | 111 | 11.1% | 116 | 9.8% | 117 | 8.8% | 119 |
| 9 | 6 | Unsuited | 11.3% | 134 | 9.8% | 135 | 8.6% | 136 | 7.7% | 134 |
| 9 | 5 | Unsuited | 9.9% | 147 | 8.5% | 148 | 7.4% | 150 | 6.6% | 149 |
| 9 | 4 | Unsuited | 8.7% | 159 | 7.3% | 160 | 6.3% | 162 | 5.6% | 162 |
| 9 | 3 | Unsuited | 8.3% | 162 | 7.1% | 163 | 6.1% | 164 | 5.4% | 165 |
| 9 | 2 | Unsuited | 8.0% | 164 | 6.8% | 164 | 5.9% | 166 | 5.2% | 166 |
| 8 | 7 | Unsuited | 13.0% | 108 | 11.4% | 110 | 10.2% | 112 | 9.2% | 112 |
| 8 | 6 | Unsuited | 11.8% | 127 | 10.3% | 128 | 9.2% | 127 | 8.3% | 126 |
| 8 | 5 | Unsuited | 10.4% | 143 | 9.0% | 143 | 8.0% | 141 | 7.2% | 141 |
| 8 | 4 | Unsuited | 9.1% | 156 | 7.8% | 156 | 6.8% | 157 | 6.1% | 157 |
| 8 | 3 | Unsuited | 7.9% | 165 | 6.7% | 167 | 5.8% | 167 | 5.1% | 167 |
| 8 | 2 | Unsuited | 7.6% | 168 | 6.4% | 168 | 5.6% | 168 | 5.0% | 168 |
| 7 | 6 | Unsuited | 12.2% | 123 | 10.7% | 120 | 9.6% | 122 | 8.8% | 121 |
| 7 | 5 | Unsuited | 11.0% | 138 | 9.7% | 137 | 8.7% | 134 | 7.9% | 132 |
| 7 | 4 | Unsuited | 9.7% | 151 | 8.5% | 149 | 7.5% | 147 | 6.8% | 146 |
| 7 | 3 | Unsuited | 8.4% | 161 | 7.2% | 162 | 6.4% | 161 | 5.7% | 161 |
| 7 | 2 | Unsuited | 7.2% | 169 | 6.2% | 169 | 5.4% | 169 | 4.8% | 169 |
| 6 | 5 | Unsuited | 11.5% | 133 | 10.1% | 131 | 9.2% | 128 | 8.4% | 125 |
| 6 | 4 | Unsuited | 10.3% | 145 | 9.1% | 142 | 8.2% | 139 | 7.5% | 137 |
| 6 | 3 | Unsuited | 9.0% | 157 | 7.9% | 155 | 7.1% | 153 | 6.5% | 151 |
| 6 | 2 | Unsuited | 7.7% | 166 | 6.7% | 166 | 6.0% | 165 | 5.4% | 164 |
| 5 | 4 | Unsuited | 11.0% | 139 | 9.8% | 134 | 8.9% | 131 | 8.2% | 128 |
| 5 | 3 | Unsuited | 9.9% | 148 | 8.8% | 146 | 8.0% | 142 | 7.3% | 140 |
| 5 | 2 | Unsuited | 8.6% | 160 | 7.6% | 158 | 6.9% | 156 | 6.3% | 154 |
| 4 | 3 | Unsuited | 9.3% | 154 | 8.3% | 152 | 7.5% | 148 | 6.9% | 145 |
| 4 | 2 | Unsuited | 8.3% | 163 | 7.3% | 161 | 6.6% | 159 | 6.0% | 158 |
| 3 | 2 | Unsuited | 7.7% | 167 | 6.8% | 165 | 6.1% | 163 | 5.6% | 163 |

1. An electronic calculator apparatus for use by a player holding a two-card hand in a game of Texas Hold'em poker, the apparatus comprising:
a keyboard including: a card identification key arrangement including one key for each of the cards of a standard 52-card deck suit; and a suitedness indicator key arrangement, such that the user,
using the card identification key arrangement, can: (i) indicate, in two keystrokes, the cards constituting said hand; and (ii) indicate the number of players, from 2-10, participating in said game and,
using the suitedness indicator key arrangement, can indicate, in a single keystroke, whether or not the cards in said hand are of the same suit; and
a screen adapted, after said user has: indicated the cards constituting said hand; indicated the number of players participating in said game; and indicated whether or not the cards in said hand are of the same suit, to display information about said hand selected from:
the pre-flop percentage odds of said hand winning the game; and
the ranking of the hand.

2. Apparatus according to claim 1, wherein the screen, in use, displays the pre-flop percentage odds of said hand winning the game and the ranking of the hand.

3. Apparatus according to claim 1, wherein the suitedness indicator key arrangement comprises a suited key and a non-suited key such that the user can indicate:
that the cards in said hand are of the same suit by a stroke of the suited key; and
that the cards in said hand are not of the same suit by a stroke of the non-suited key.

4. Apparatus according to claim 1, wherein:
the keyboard further comprises a player number key and
a stroke of the player number key triggers the apparatus to interpret further activation of a numeric key of the card identification key arrangement as an indication of the number of players participating in said game.

5. Apparatus according to claim 1, wherein:
the keyboard further comprises a calculate key; and
a stroke of the calculate key triggers the display of said information about said hand.

6. Apparatus according to claim 1, adapted such that, after a user has:
(i) indicated the cards in said hand using the card identification key arrangement;
(ii) using the suitedness indicator key arrangement, indicated, via a single keystroke, whether or not the cards of said hand are of the same suit or not; and
(iii) indicated the number of players in the game using the card identification key arrangement,
the screen displays the pre-flop percentage odds of said hand winning the game and the ranking of the hand.

7. Apparatus according to claim 6, wherein
the keyboard further comprises a calculate key; and
a stroke of the calculate key triggers the screen to display said information about said hand.

8. Apparatus according to claim 7, wherein:
the keyboard further comprises a player number key; and
a stroke of the player number key triggers further activation of a numeric key of the card identification key arrangement to be interpreted as an indication of the number of players participating in said game.

9. Apparatus according to claim 1, having outer dimensions substantially equivalent to a stack of standard playing cards.

10. Apparatus according to claim 1, adapted to receive sufficient data to display said information about said hand in 6 or fewer keystrokes.
